(19) United States
(12) Patent Application Publication
(10) Pub. No.: US 2009/0024239 A1
(43) Pub. Date: Jan. 22, 2009

(54) Work management apparatus and work management method

(75) Inventors: Kouji Yoshioka, Kawasaki (JP); Tomohiko Maeda, Kawasaki (JP); Kazayuki Furukawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/149,252

(22) Filed: Apr. 29, 2008

(30) Foreign Application Priority Data
Jul. 17, 2007 (JP) 2007-185147

(51) Int. Cl. G06F 19/00

(52) U.S. Cl. 700/110; 700/111

(57) ABSTRACT

A work management apparatus of the present invention includes bar-code readers that detect the input and output of target objects to and from each facility in each facility, a process management device that obtains, as workpiece information, information of date and time when the target objects enter into each facility and information of date and time when the target objects come out from each facility for every target object and every facility based on the detection results of the bar-code readers, sensors that detect operating conditions of each facility, and an analysis device that analyzes and outputs the operating conditions of each facility and the work progress of the target objects in each facility based on the obtained workpiece information and the information indicating the detected operating conditions of each facility.

### CROSS-REFERENCE TO RELATED APPLICATIONS

This application claims the conventional priority based on Japanese Application No. 2007-185147, filed on Jul. 17, 2007, the disclosures of which are incorporated herein by reference.

### BACKGROUND OF THE INVENTION

1. Field of the Invention

The present invention relates to a work management apparatus, and more particularly, to a work management apparatus and a work management method that analyze and output operating conditions of each facility and work progress of target objects in each facility.

2. Description of the Related Art

FIG. 23 depicts a conventional work management apparatus. The conventional work management apparatus shown in FIG. 23 includes a process management device 10, operation management devices 13-1 to 13-4, revolving lamps 14-1 to 14-4, bar-code readers 12-1 and 12-2, and a failure daily report 16. Reference numerals 11-1 to 11-4 in FIG. 23 denote facilities that work on workpieces, and reference numeral 15 denotes a database stored with information read out by each operation management device. The workpiece refers to a target object.

The process management device 10 is a device that is connected to the facility 11-1 which is a facility of the leading process and the facility 11-4 which is a facility of the final process. The process management device 10 records the passage (input/completion) of workpieces as workpiece information and compiles a database.

The bar-code readers 12-1 and 12-2 are devices that are respectively connected to the facility 11-1 which is a facility of the leading process and the facility 11-4 which is a facility of the final process. The bar-code readers 12-1 and 12-2 detect passing of the workpieces through the facilities and register the detection results to the process management device 10.

The operation management devices 13-1 to 13-4 are devices installed in respective facilities and read out signals indicating that the facilities are normal or abnormal, and then determine normal/abnormal of the facilities. The read out information is stored in the database 15.

The revolving lamps 14-1 to 14-4 are reporting devices that are respectively connected to the operation management devices and report in real time the judgment results of the operation management devices in relation to normal/abnormal of the facilities. The lighting patterns or the colors of the lighting lamps are changed depending on the operation conditions of the facilities. Looking at the lighting of the revolving lamp, the operator recognizes that the facility equipped with the revolving lamp is in an abnormal state and creates a failure report.

The failure daily report 16 is information recorded with failure reports of facilities created by the operator.

The conventional work management apparatus shown in FIG. 23 performs real time monitoring with the revolving lamps to manage the operating conditions of the facilities, finds the cause of failure, and records log information of the operating conditions of each facility to improve the operation of the facilities. There are various kinds of facility failures, which are closely related to the types of workpieces inputted to the facilities. Therefore, in a conventional work management apparatus, an operation management device and a process management device are connected to each facility, and information related to operating conditions of facilities and the production progress of products is obtained for management.

When a failure occurs to a certain facility, the revolving lamp lights up. The operator moves to the facility in which the revolving lamp has lighted up and deals with the failure, and then records the result in the failure daily report 16.

An example of a conventional technology for collecting operating conditions of the production line is described in Japanese Patent Laid-Open NO. 5-123946 related to a system in which the arrival of a product to each process is detected, the working hours is calculated based on the identification information of the product and the detection result, and warns and reports based on the comparison result of the calculated working hours and the standard hours.

The conventional work management apparatus described with reference to FIG. 23 has following problems. The problems of the conventional work management apparatus will now be described with reference to FIG. 24.

As shown in FIG. 24, for example, once a failure such as error shutdown occurs in the facility 11-3, the revolving lamp 14-3 lights up, and the operator immediately responds to it. However, the revolving lamps are managed on a facility by facility basis, and thus, if the response by the operator is delayed, the facility 11-2, which is a facility of the previous process of the process in which the failure has occurred, cannot supply a workpiece to the next process. As a result, the operation management device 13-2 determines that a failure has occurred, and the revolving lamp 14-2 corresponding to the facility 11-2 lights up. Similarly, the facility 11-1, which is a facility of the previous process of the process in the facility 11-2, cannot supply a workpiece to the next process, and as a result, the revolving lamp 14-1 corresponding to the facility 11-1 lights up.

Furthermore, the facility 11-4, which is a facility of the following process of the process in which the failure has occurred, determines that a failure has occurred because the workpiece is not supplied from the facility 11-3, and the revolving lamp 14-4 corresponding to the facility 11-4 lights up. In this way, when the response by the operator is delayed, the failure spreads over the entire manufacturing line, and a plurality of revolving lamps light up. Thus, from which facility the failure has occurred cannot be determined with revolving lamps alone. A method may be employed in which operators are deployed to all facilities and only the revolving lamps are monitored at all times, but the method is unrealistic.

When there is even one facility in the production line whose operation is not properly managed, the overall situation cannot be correctly figured out. Thus, expensive sensors need to be additionally installed for systemization.

In addition, conventionally, there has been no system in which inexpensive sensors are mounted on each facility to detect operation conditions of the facilities and then analyze the detection result of the operating conditions of the facilities on software.

### SUMMARY OF THE INVENTION

It is an object of the present invention to provide a work management apparatus capable of identifying in which facility an abnormality has occurred by analyzing and outputting the operating conditions of each facility and the work progress of the target objects in each facility, and capable of identifying, for example, at what time and in which facility each target object is being manufactured.

It is another object of the present invention to provide a work management method capable of identifying in which facility an abnormality has occurred by analyzing and outputting the operating conditions of each facility and the work progress of the target objects in each facility, and capable of identifying, for example, at what time and in which facility each target object is being manufactured.

The work management apparatus of the present invention is the work management apparatus in a manufacturing line in which one or a plurality of target objects are manufactured in a plurality of facilities. The work management apparatus comprises a first detection unit arranged on each facility and detecting the input and output of the target objects to and from each facility in each facility, a workpiece information obtaining unit for obtaining, as workpiece information, information of date and time when the target objects enter into each facility and information of date and time when the target objects come out from each facility for every target object and every facility based on the detection result of the first detection unit, a second detection unit arranged on each facility and detecting operating conditions of each facility, and an analysis unit for analyzing the operating conditions of each facility and the work progress of the target objects in each facility based on the obtained workpiece information and the information indicating the operating conditions of each facility detected by the second detection unit, and outputting the analysis result.

Preferably, the analysis unit comprises an operating condition obtaining unit for obtaining information indicating the operating conditions of each facility detected by the second detection unit, and a work progress past record information creation unit for creating work progress past record information indicating the past records of the work progress of the target objects in each facility based on the obtained information indicating the operating conditions of each facility and the workpiece information obtained by the workpiece information obtaining unit.

Preferably, the analysis unit further comprises a matching processing unit for comparing the operating conditions of each facility with reference data of operating conditions of each facility stored in advance in a storage unit and modifying the information indicating the operating conditions of each facility to matched information based on the comparison result.

Preferably, the operating condition obtaining unit displays in real time a facility that has become abnormal based on the obtained operating conditions of each facility.

Preferably, the analysis unit further comprises a work progress past record information display unit for displaying work progress past record information created by the work progress past record information creation unit.

Preferably, the work progress past record information display unit creates and displays a Gantt chart indicating the operating conditions of each facility and the past records of the work progress of each target object based on the work progress past record information.

Preferably, the work progress past record information display unit creates a Gantt chart in which the information indicating each work and the information indicating the operating conditions of facility in each work are associated.

Preferably, the work progress past record information display unit creates information indicating the context of works in each facility based on the work progress past record information and displays the information in the Gantt chart.

The work management method of the present invention is the work management method in a manufacturing line in which one or a plurality of target objects are manufactured in a plurality of facilities. The work management method comprises a step of detecting, in a first detection unit arranged on each facility, the input and output of the target objects to and from each facility in each facility, a step of obtaining, as workpiece information, information of date and time when the target objects entering into each facility and information of date and time when the target objects come out from each facility for every target object and every facility based on the detection result of the first detection unit, a step of detecting, in a second detection unit arranged on each facility, operating conditions of each facility, and a step of analyzing the operating conditions of each facility and the work progress of the target objects in each facility based on the obtained workpiece information and the operating conditions of each facility detected by the second detection unit, and outputting the analysis result.

The work management apparatus and the work management method of the present invention analyze and output the operating conditions of each facility and the work progress of the target objects in each facility. Preferably, the work management apparatus of the present invention creates work progress past record information indicating the past records of the work progress of the target objects in each facility based on the information indicating the operating conditions of each facility and the workpiece information. Therefore, according to the present invention, in which facility an abnormality has occurred can be identified, and, for example, at what time and in which facility each target object is being manufactured can be identified. As a result, for example, a facility being a bottleneck can be automatically calculated, and measures can be taken such as raising the monitoring level of the facility being the bottleneck.

The work management apparatus of the present invention modifies information indicating the operating conditions of each facility to matched information based on the comparison result of the operating conditions of each facility and the reference data, and analyzes the operating conditions of each facility and the work progress of the target objects in each facility based on the matched information and the workpiece information. As a result, according to the present invention, the operating conditions of each facility and the work progress of the target objects in each facility can be analyzed accurately.

The work management apparatus of the present invention displays in real time the facility that has become abnormal based on the obtained operating conditions of each facility. As a result, according to the present invention, a user can recognize in real time the facility that has become abnormal.

The work management apparatus of the present invention displays the created work progress past record information. Preferably, the work management apparatus of the present invention creates and displays a Gantt chart indicating the operating conditions of each facility and the past records of the work progress of each target object based on the work progress past record information. As a result, according to the present invention, a user can check, for example, at what time and in which facility each target object is being manufactured and the operating conditions of each facility in each time frame by looking at the Gantt chart.

The work management apparatus of the present invention creates a Gantt chart in which the information indicating each work and the information indicating operating conditions of facility in each work are associated. As a result, according to the present invention, a user can check, for example, a facility performing a work of manufacturing is in an operating condition, error shutdown, or blocked state, by looking at the Gantt chart.

The work management apparatus of the present invention displays in a Gantt chart information indicating the context of works in each facility. As a result, according to the present invention, a user can check, for example, the works before and after the works of a certain target object in a certain facility by looking at the Gantt chart.

### BRIEF DESCRIPTION OF THE DRAWINGS

FIG. 1 is a diagram showing an example of a structure of a work management apparatus of the present invention.

FIG. 2 depicts an example of workpiece information.

FIG. 3 is a diagram showing an example of a structure of an analysis device.

FIG. 4 depicts an example of displaying facility operation signal data.

FIG. 5 depicts an example of the facility operation signal data.

FIG. 6 depicts an example of facility operation information.

FIG. 7 depicts an example of a work progress past record information creation process flow in an embodiment of the present invention.

FIG. 8 depicts an example of the facility operation signal data.

FIG. 9 depicts an example of the facility operation information.

FIG. 10 depicts an example of a Gantt chart.

FIGS. 11 and 12 are diagrams showing an example of a creation process flow of work progress past record information.

FIG. 13 depicts an example of the facility operation information.

FIG. 14 depicts an example of the workpiece information.

FIG. 15 depicts an example of temporary data.

FIG. 16 depicts an example of a facility sequence chart.

FIGS. 17 and 18 depict an example of the work progress past record information.

FIG. 19 is a diagram showing an example of a display process flow of the work progress past record information.

FIGS. 20 and 21 are diagrams showing examples of displaying the work progress past record information.

FIGS. 22A and 22B are diagrams showing examples of displaying the work progress past record information.

FIG. 23 is a diagram showing a conventional work management apparatus.

FIG. 24 is an explanatory view of problems of the conventional work management apparatus.

### DETAILED DESCRIPTION OF THE PREFERRED EMBODIMENTS

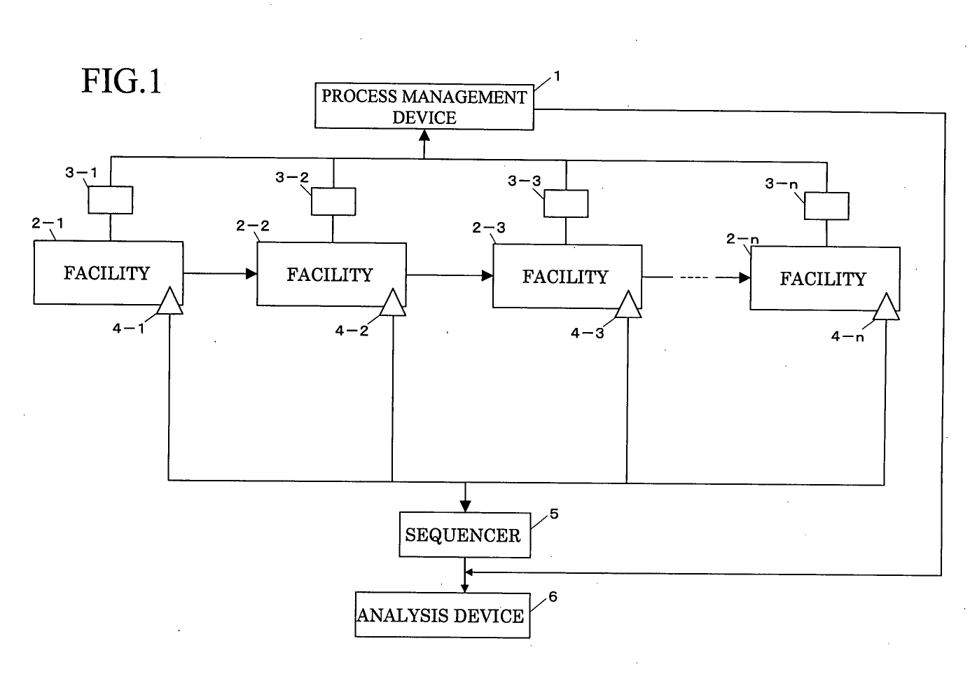

FIG. 1 is a diagram showing an example of a structure of a work management apparatus of the present invention. The work management apparatus of the present embodiment is a work management apparatus in a manufacturing line in which one or a plurality of target objects are manufactured in a plurality of facilities (facilities 2-1 to 2-n). The work management apparatus analyzes operating conditions of each facility and work progress of the target objects in each facility and then outputs the analysis result.

The work management apparatus of the present embodiment includes a process management device 1, bar-code readers 3-1 to 3-n, sensors 4-1 to 4-n, a sequencer 5, and an analysis device 6.

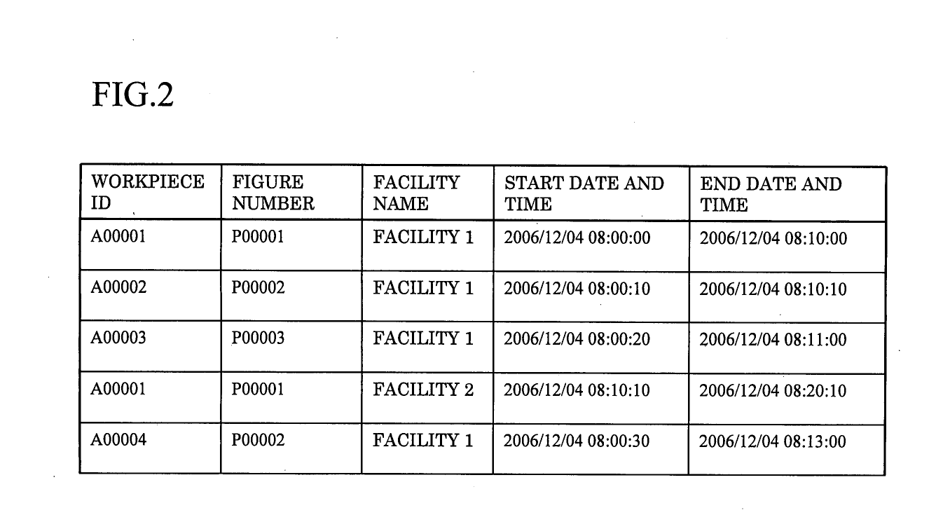

The process management device 1 obtains detection results of the input and output of target objects to and from each facility in each facility, the detection results detected by each bar-code reader connected to the facility of each process, and obtains workpiece information based on the detection results. The workpiece information is information of date and time when the target objects enter into each facility and information of date and time when the target objects come out from each facility, for every target object and every facility. Specifically, as shown in FIG. 2, the workpiece information has a data structure including, for example, workpiece ID, figure number, facility name, start date and time, and end date and time. The workpiece ID denotes identification information for uniquely identifying the target objects (workpieces). The figure number denotes the figure number of a workpiece, the facility name denotes the title of a facility, the start date and time denotes date and time when a workpiece has entered into the facility, and the end date and time denotes date and time when a workpiece has come out from the facility. The process management device 1 notifies the obtained workpiece information to the analysis device 6 described below.

The bar-code readers, 3-1, 3-2, 3-3, . . . , and 3-n are respectively connected to the facilities 2-1, 2-2, 2-3, . . . , and 2-n, respectively detect inputs and outputs of the target objects to and from the facilities 3-1, 3-2, 3-3, . . . , and 3-n, and notify the detection results to the process management device 1.

Specifically, each bar-code reader reads out the workpiece ID and the figure number of a workpiece recorded in the bar-code attached in advance to a target object when the target object enters into the facility to which the bar-code reader is connected. When the target object comes out from the facility to which the bar-code reader is connected, each bar-code reader reads out the workpiece ID and the figure number of the workpiece recorded in the bar-code attached in advance to the target object. Each bar-code reader then notifies, to the process management device 1, information of the read out workpiece ID, the figure number of the workpiece, the date and time of when the workpiece has entered into the facility, and the date and time of when the workpiece has come out from the facility, together with the identification information (for example, name of the facility) of the facility to which the bar-code reader is connected. The process management device obtains the workpiece information based on, for example, the information notified by each bar-code reader.

The sensors 4-1, 4-2, 4-3, . . . , and 4-n are respectively installed in the facilities 2-1, 2-2, 2-3, . . . , 2-n, respectively detect facility operation signals of the facilities 2-1, 2-2, 2-3, . . . , and 2-n, and notify the detected facility operation signals to the analysis device 6. The facility operation signals are signals indicating operating conditions of the facilities, and more specifically, the facility operation signals are control signals of programs causing the facilities to operate. The sensors are, for example, photoelectric sensors.

The sequencer 5 is a device that collectively obtains the facility operation signals from each sensor and that notifies all obtained facility operation signals to the analysis device 6 as facility operation signal data.

The analysis device 6 obtains the facility operation signal data from the sequencer 5 and obtains the workpiece information from the process management device 1, and then analyzes the operating conditions of each facility and the work progress of the target objects in each facility based on the obtained facility operation signal data and the workpiece information, and outputs the analysis results.

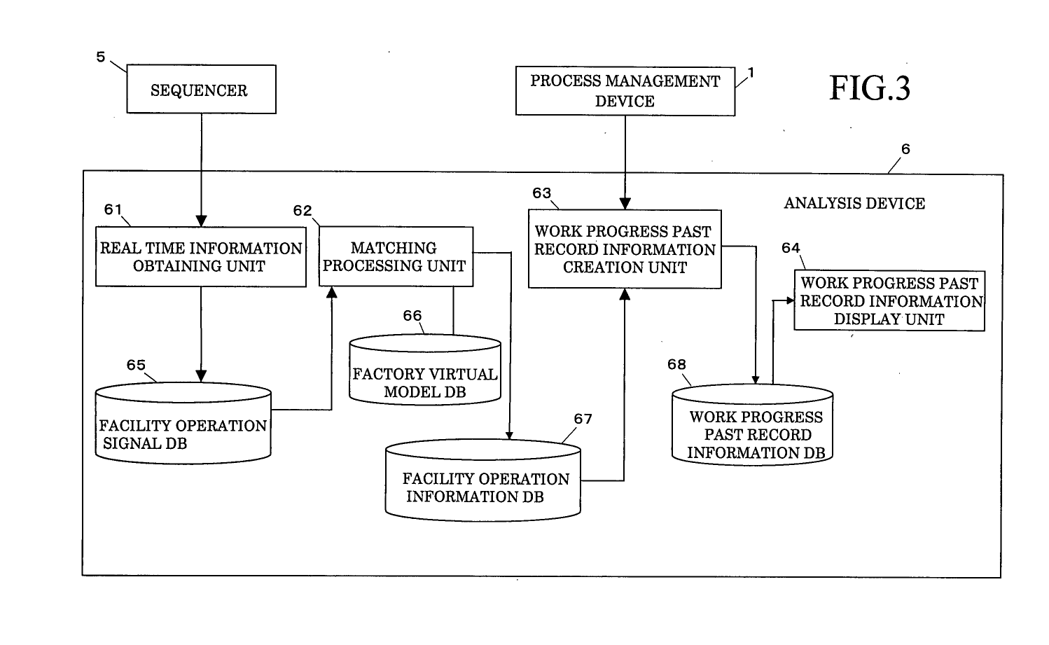

FIG. 3 is a diagram showing an example of a structure of the analysis device shown in FIG. 1. The analysis device 6 includes a real time information obtaining unit 61, a matching processing unit 62, a work progress past record information creation unit 63, a work progress past record information display unit 64, a facility operation signal database (DB) 65, a factory virtual model database (DB) 66, a facility operation information database (DB) 67, and a work progress past record information database (DB) 68.

The real time information obtaining unit 61 obtains the facility operation signal data in real time through the sequencer 5 and stores the obtained facility operation signal data in the facility operation signal DB 65. In other words, the real time information obtaining unit 61 is an operating condition obtaining unit for obtaining information indicating the operating conditions of each facility detected by each sensor.

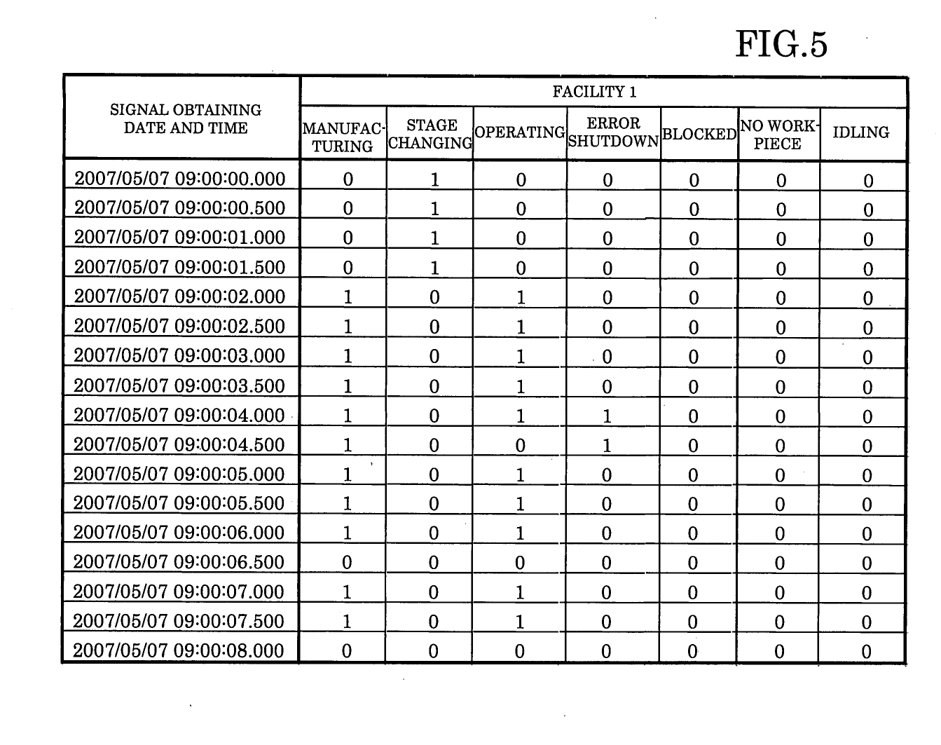

Signal obtaining date and time and operating conditions (manufacturing, stage changing, operating, error shutdown, blocked, no workpiece, idling) of the facilities are written in the facility operation signal data as shown in FIG. 5 described below. The record (data of one line) of the facility operation signal data shown in FIG. 5 is the facility operation signal.

Manufacturing is a state of a workpiece being set in the facility. Stage changing is a state of the facility being temporarily halted for changing the stage. Operating is a state of the facility manufacturing relative to a workpiece. Error shutdown is a state of the facility being halted due to abnormality. Blocked is a state in which a workpiece cannot be moved to the facility of the following process. No workpiece is a state in which a workpiece cannot be moved to the facility of the following process because there is no workpiece in the facility of the previous process. Idling is a state of the facility in operation but not working (waiting state). As shown in FIG. 5 described below, the facility operation signal is indicated with, for example, “1”, when the operating condition of the facility corresponding to the facility operation signal is “On” (in other words, when the facility is in an operating condition), and indicated with “0” when the operating condition is “Off” (in other words, when the facility is not in the operating condition).

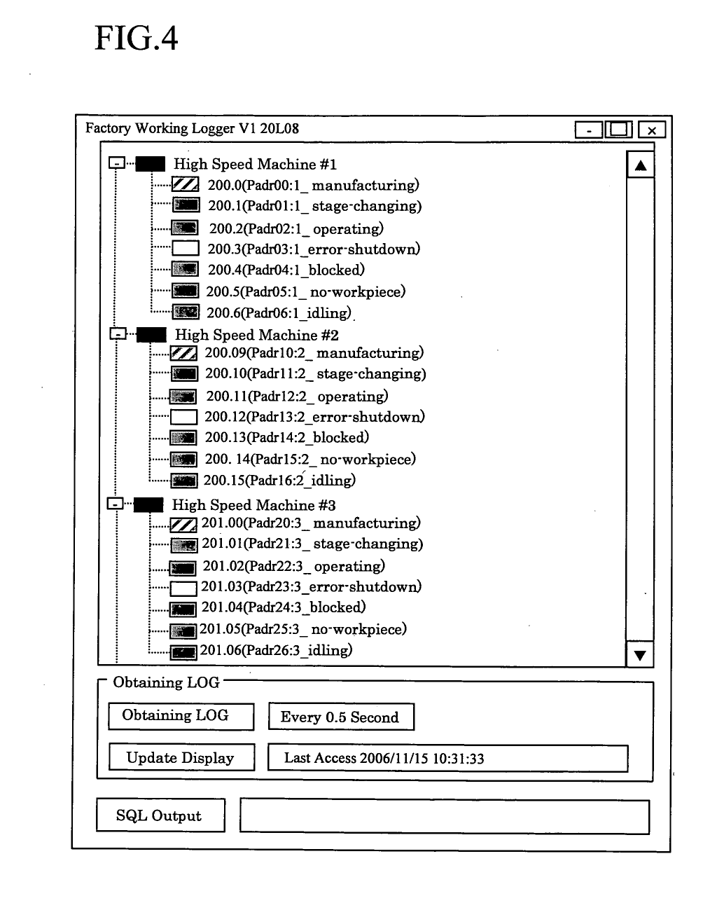

According to the present embodiment, the real time information obtaining unit 61 displays a facility that has become abnormal in real time by displaying the obtained facility operation signal data (information indicating the operating conditions of each facility) in real time as shown in FIG. 4.

In the example shown in FIG. 4, the operation conditions of each facility (high speed machine in FIG. 4) at the point of 10:31:33 of Nov. 15, 2006 are displayed. When a facility operation signal indicating the error shutdown is “On” in a high speed machine #1, the real time information obtaining unit 61 may, for example, display that the high speed machine #1 is in a state of error shutdown by changing the color of icon indicating the error shutdown or with other methods.

The operating conditions of each facility can be checked on one screen by the real time information obtaining unit 61 displaying the facility operation signal data in real time. According to the present embodiment, the real time information obtaining unit 61 may notify the operator of a warning message when a failure occurs in a facility. Looking at the warning message, the operator can check information such as the name of the facility in which the failure has occurred and the cause of failure, and can accurately recognize the facility that should be dealt with.

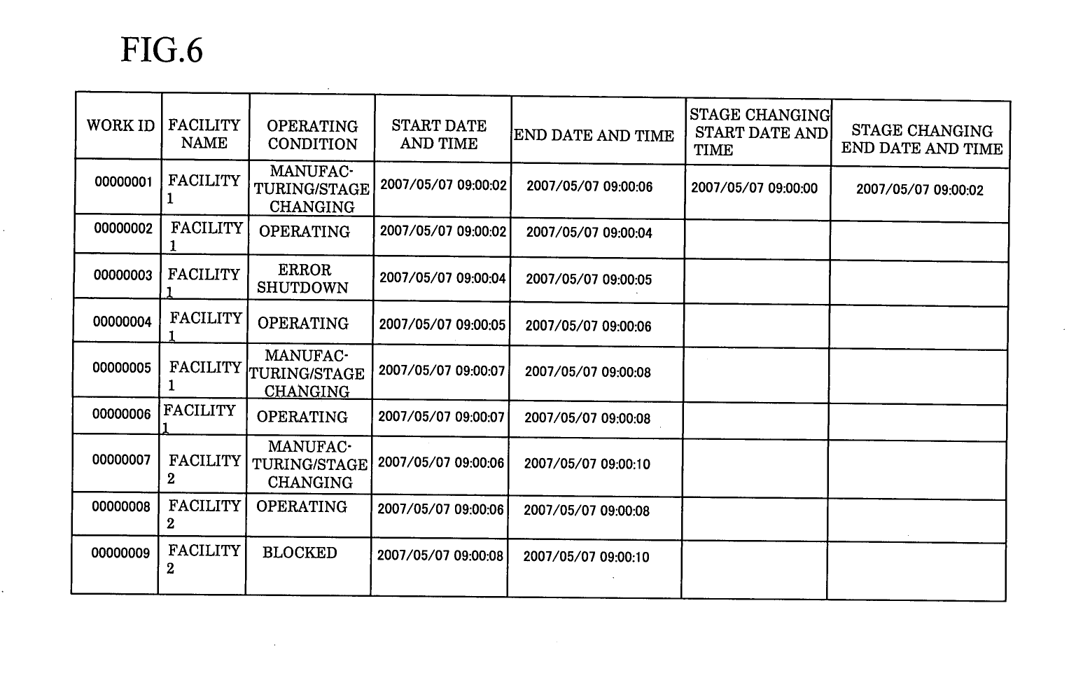

The matching processing unit 62 creates facility operation information shown in FIG. 6 described below based on the facility operation signal data stored in the facility operation signal DB 65. When creating the facility operation information, the matching processing unit 62 compares the facility operation signal data and factory virtual models recorded in advance in the factory virtual model DB 66, modifies the facility operation signal to matched information based on the comparison result, creates the facility operation information, and stores the created facility operation information in the facility operation information DB 67. The factory virtual models are simulation results of the operating conditions of each facility and reference data of the operating conditions of each facility. The matching processing unit 62, for example, modifies conflicting facility operation signal data as a result of the comparison with the factory virtual models.

In other words, the matching processing unit 62 is a matching processing unit for comparing the information indicating the operating conditions of each facility with the reference data of the operating conditions of each facility stored in advance in the factory virtual model DB 66 and modifying the information indicating the operating conditions of each facility to matched information based on the comparison result.

The work progress past record information creation unit 63 creates work progress past record information which is information indicating the past records of the work progress of the target objects in each facility based on the facility operation information stored in the facility operation information DB 67 and the workpiece information notified from the process management device 1. The work progress past record information creation unit 63 may create the work progress past record information indicating the past records of the work progress of the target objects in each facility based on the facility operation signals in the facility operation signal DB 65 and the workpiece information notified by the process management device 1. In other words, the work progress past record information creation unit 63 is a work progress past record information creation unit for creating the work progress past record information indicating the past records of the work progress of the target objects in each facility based on the information indicating the operating conditions of each facility obtained by the real time information obtaining unit 61 and the workpiece information obtained by the process management device 1. The work progress past record information creation unit 63 stores the created work progress past record information in the work progress past record information DB 68.

The work progress past record information display unit 64 displays the work progress past record information stored in the work progress past record information DB 68. The work progress past record information display unit 64 inputs extraction conditions (for example, period and figure number) of the work progress past record information in accordance with, for example, the designation and input by the operator. The work progress past record information display unit 64 then extracts the work progress past record information from the work progress past record information DB 68 in accordance with the inputted extraction conditions and displays the extracted work progress past record information. In other words, the work progress past record information display unit 64 is a work progress past record information display unit for displaying the work progress past record information created by the work progress past record information creation unit 63.

According to the embodiment of the present invention, the work progress past record information display unit 64 may further create and display a Gantt chart indicating the operating conditions of each facility and the past records of the work progress of each target object based on the work progress past record information stored in the work progress past record information DB 68. The Gantt chart is a process management diagram showing the work plan and the schedule in a horizontal bar graph. For example, in the Gantt chart, work is illustrated on the vertical axis (row), period is illustrated on the horizontal axis, and the required period of each work is illustrated with a horizontal bar having a length proportional to the required period.

According to the embodiment, the work progress past record information display unit 64 may further create a Gantt chart in which the information indicating each work and the information indicating operating conditions of facility in each work are associated.

According to the embodiment, the work progress past record information display unit 64 may further create the information indicating the context of the work in each facility based on the work progress past record information and display the information in the Gantt chart.

According to the embodiment, the work progress past record information display unit 64 may further display the facility operation information created by the matching processing unit 62.

The work management apparatus of the embodiment and the functions of each device included in the work management apparatus are realized by a CPU and programs executed thereon. The programs realizing the present embodiment can be stored in computer-readable recording media such as a semiconductor memory, a hard disk, a CD-ROM, or a DVD, and are provided recorded in these recording media or through transmission and reception using a network via a communication interface.

FIG. 5 is an example of the facility operation signal data. The facility operation signal data includes information indicating the operating conditions (for example, manufacturing, stage changing, operating, error shutdown, blocked, no workpiece, and idling) of the facility for every date and time in which the facility operation signals are obtained and for every facility. FIG. 5 illustrates an example of the facility operation signal data in relation to the facility 1. The number “1” described as operating conditions of the facility denotes that the facility is in an operating condition, while the number “0” denotes that the facility is not in an operating condition.

FIG. 6 depicts an example of the facility operation information. The facility operation information includes, for example, work ID, facility name, operating condition, start date and time, end date and time, stage changing start date and time, and stage changing end date and time. The work ID denotes an identifier that uniquely identifies the work in a facility. In other words, the record (data of one line) of the facility operation information denotes one work. Examples of the operating conditions of a facility performing a work of manufacturing include operating, no workpiece, error shutdown, idling, and blocked. The facility name denotes the title of a facility, and the operating condition denotes the operating condition of a facility. The start date and time denotes the start date and time of the operating condition. The end date and time denotes the end date and time of the operating condition. When the operating condition is manufacturing or stage changing (when manufacturing/stage changing is stored in the item of “operating condition”), the start date and time of manufacture is stored as the start date and time, while the end date and time of manufacture is stored as the end date and time. The stage changing start date and time denotes the start date and time of stage changing, and the stage changing end date and time denotes the end date and time of stage changing.

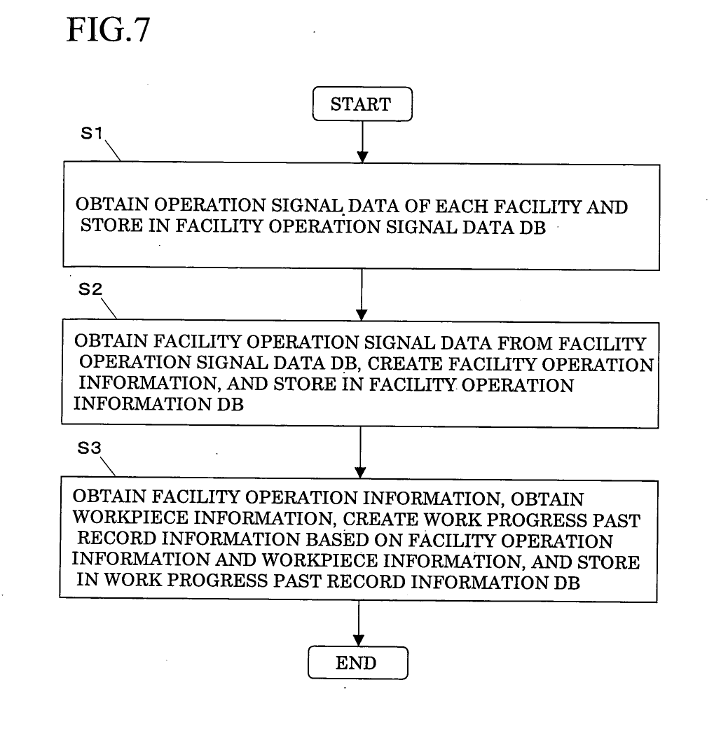

FIG. 7 depicts an example of a work progress past record information creation process flow in the present embodiment. The real time information obtaining unit 61 first obtains in real time the facility operation signal data of each facility through the sequencer 5 and stores the facility operation signal data in the facility operation signal data DB 65 in step S1.

The matching processing unit 62 then automatically obtains the facility operation signal data at certain intervals from the facility operation signal data DB 65, creates facility operation information, and stores the facility operation information in the facility operation information DB 67 in step S2. The work progress past record information creation unit 63 then automatically obtains the facility operation information at certain intervals from the facility operation information DB 67, obtains the workpiece information from the process management device 1, creates work progress past record information based on the facility operation information and the workpiece information, and stores the work progress past record information in the work progress past record information DB 68 in step S3.

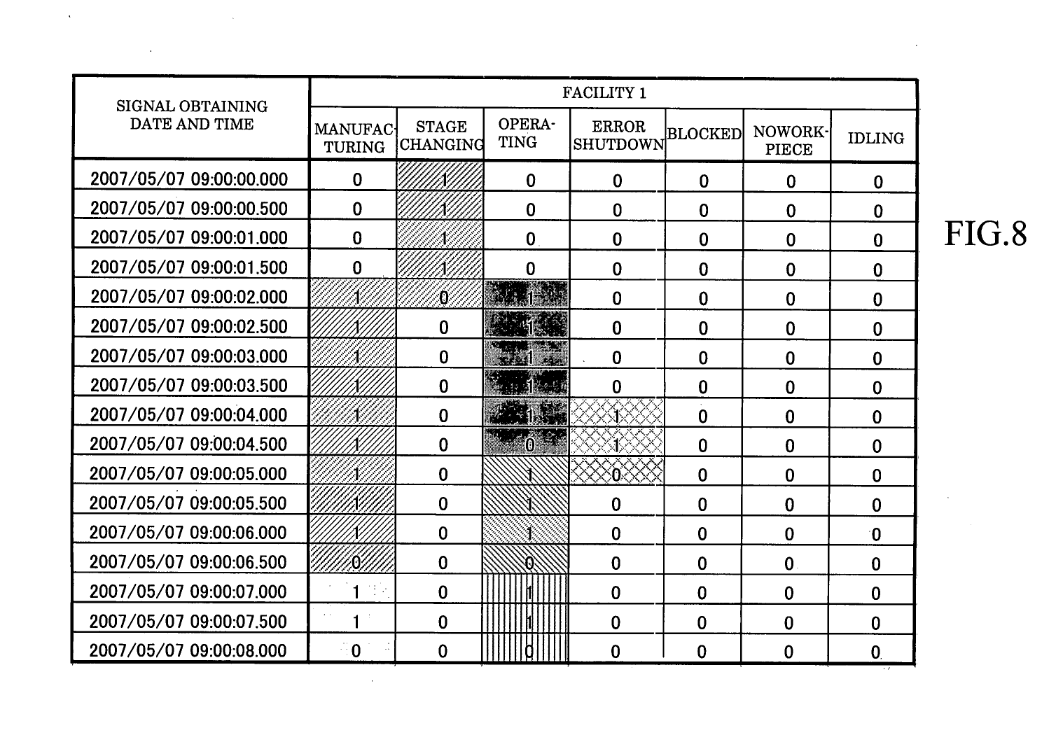

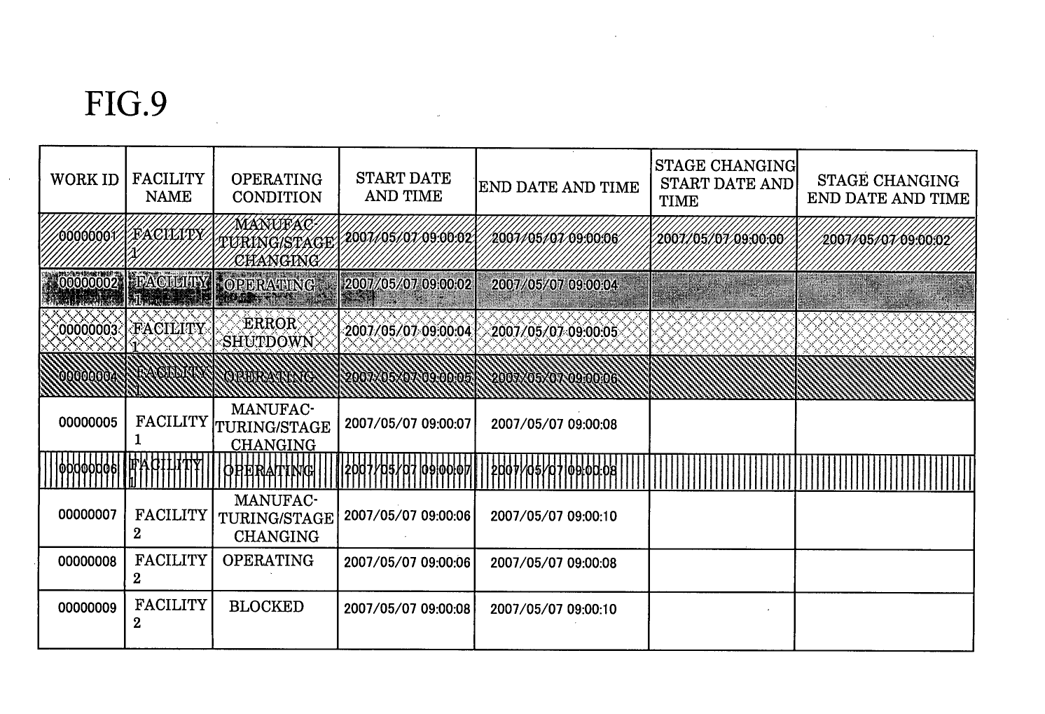

The creation of the facility operation information in step S2 will now be described. The matching processing unit 62 searches, in the facility operation signal data shown in FIG. 8 for example, the point where the signal sate of the field (column) of each operating condition has become “1” to the point where the signal sate becomes “0”, and stores the date and time of when the signal state has become “1” in the item of “start date and time” corresponding to the operating condition of the facility operation information shown in FIG. 9. The matching processing unit 62 also stores the date and time of when the signal state has become “0” into the item of “end date and time” corresponding to the operating condition of the facility operation information shown in FIG. 9. As for the operating condition of stage changing, the matching processing unit 62 stores the date and time of when the signal state of the facility operation signal indicating stage changing in the facility operation signal data has become “1” in the item of “stage changing start date and time” of the facility operation information, and stores the date and time of when the signal state has become “0” in the item of “stage changing end date and time” of the facility operation information.

The matching processing unit 62, for example, rounds down the date and time information obtained by searching the facility operation signal data to the nearest second when storing the date and time information to “start date and time”, “end date and time”, “stage changing start date and time”, and “stage changing end date and time” of the facility operation information. For example, when the date and time information obtained by searching the facility operation signal data is 2007/05/07 09:00:05.500, the matching processing unit 62 regards the date and time information as 2007/05/07 09:00:05 to form the date and time information stored in the facility operation information.

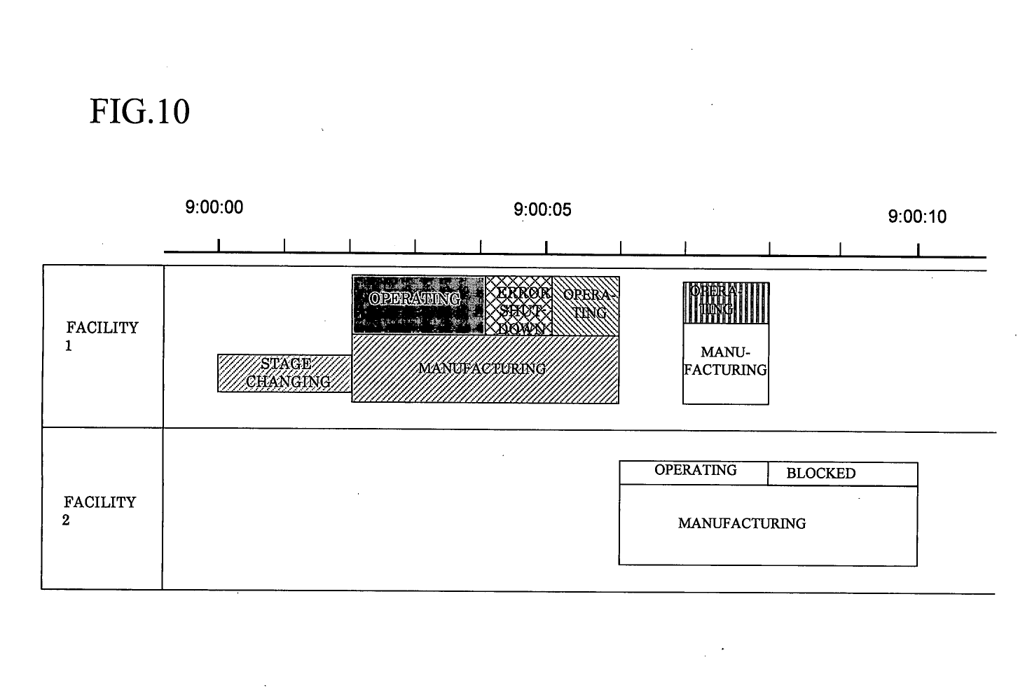

The facility operation information shown in FIG. 9 is created from the facility operation signal data shown in FIG. 8 for example by the matching processing unit 62 executing the above described creation process of the facility operation information. The work progress past record information display unit 64, for example, displays the facility operation information shown in FIG. 9 in a form of the Gantt chart as shown in FIG. 10.

The creation process of the work progress past record information in step S3 of FIG. 7 will now be described.

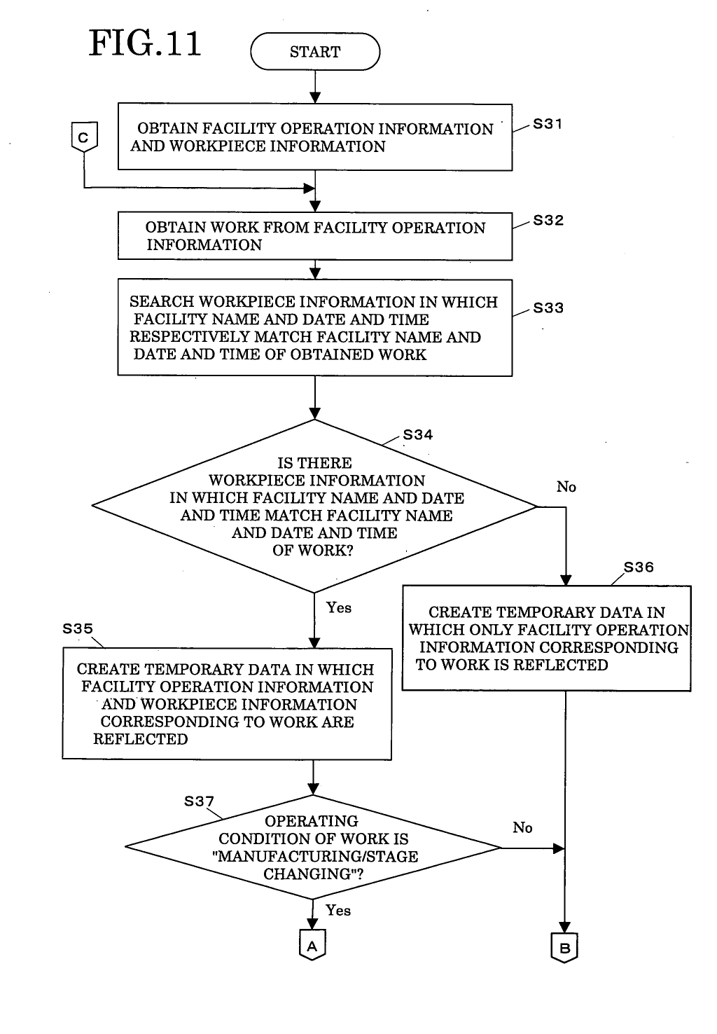

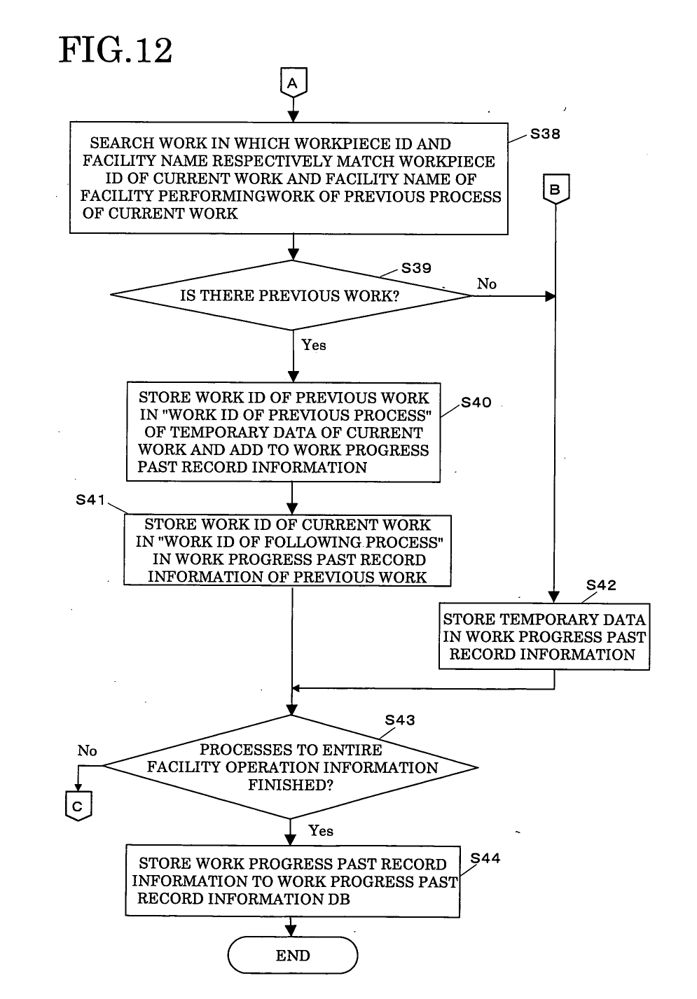

FIGS. 11 and 12 depict a detailed example of the creation process flow of the work progress past record information.

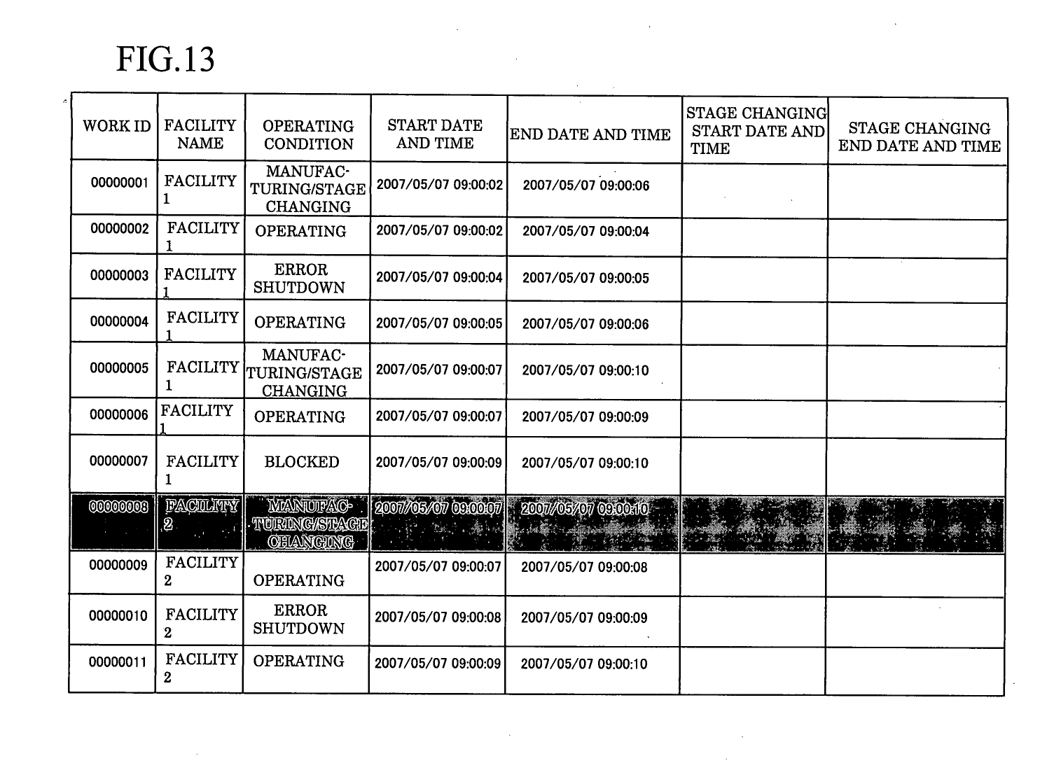

The work progress past record information creation unit 63 first obtains the workpiece information from the process management device 1 and obtains the facility operation information from the facility operation information DB 67 in step S31. In in step S32, the work progress past record information creation unit 63 obtains a work from the facility operation information obtained in the step S31. The work progress past record information creation unit 63, for example, refers to the facility operation information shown in FIG. 13 to obtain the record (data of one line) whose work ID is “00000008” as the work.

In step S33, the work progress past record information creation unit 63 searches the workpiece information in which the facility name and the date and time respectively match the facility name and the date and time of the work obtained in the step S32. The matching criteria of the date and time in the step S33 is defined as, for example, start date and time of work≧start date and time of workpiece information, in addition to, end date and time of work≦end date and time of workpiece information.

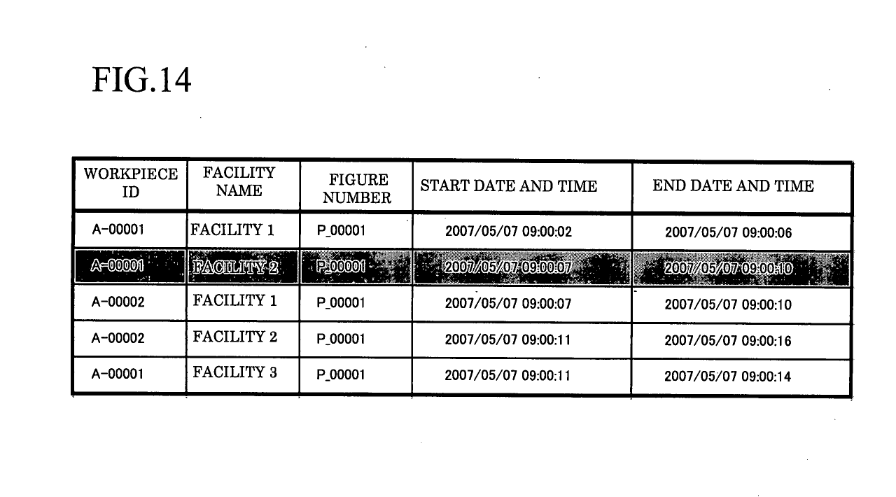

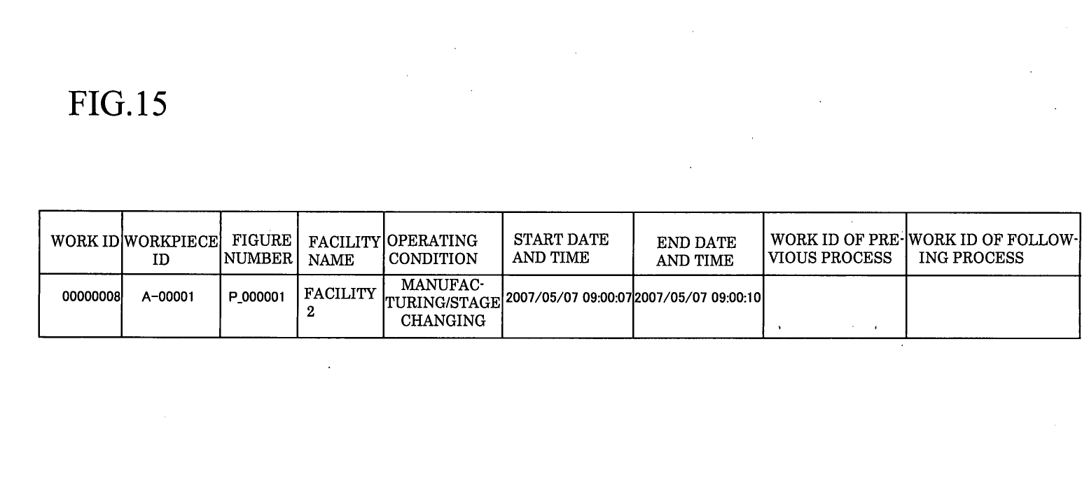

The work progress past record information creation unit 63 determines whether there is workpiece information in which the facility name and the date and time (start date and time and end date and time) match the facility name and the date and time (start date and time and end date and time) of the work in step S34. When the work progress past record information creation unit 63 determines that there is workpiece information in which the facility name and the date and time match the facility name and the date and time of the work, the work progress past record information creation unit 63 creates temporary data in which the facility operation information and the workpiece information corresponding to the work are reflected in step S35. In the step S35, for example, from the workpiece information shown in FIG. 14, the work progress past record information creation unit 63 identifies workpiece information whose workpiece ID is “A-00001” in which the facility name and the date and time respectively match the facility name (facility 2) and the date and time of the facility operation information whose work ID is “00000008” shown in FIG. 13. The work progress past record information creation unit 63 then adds the workpiece ID and the figure number of the identified workpiece information to the facility operation information whose work ID is “00000008”, adds the field corresponding to “work ID of previous process” in which storage data is empty and the field corresponding to “work ID of following process” in which storage data is empty to the facility operation information, and creates temporary data as shown in FIG. 15.

When the work progress past record information creation unit 63 determines that there is no workpiece information in which the facility name and the date and time match the facility name and the date and time of the work, the work progress past record information creation unit 63 creates temporary data in which only the facility operation information corresponding to the work is reflected in step S36 and the process proceeds to step S42 of FIG. 12.

Subsequent to the step S35, the work progress past record information creation unit 63 determines whether the operation condition of the work is “manufacturing/stage changing” in step S37. When the work progress past record information creation unit 63 determines that the operating condition of the work is “manufacturing/stage changing”, the process proceeds to step S38 of FIG. 12. When the work progress past record information creation unit 63 determines that the operating condition of the work is not “manufacturing/stage changing”, the process proceeds to step S42 of FIG. 12. In the step S42, the work progress past record information creation unit 63 adds the temporary data to the work progress past record information, and the process proceeds to step 43 of FIG. 12.

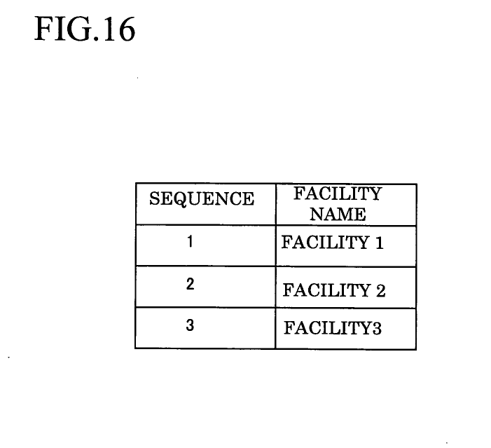

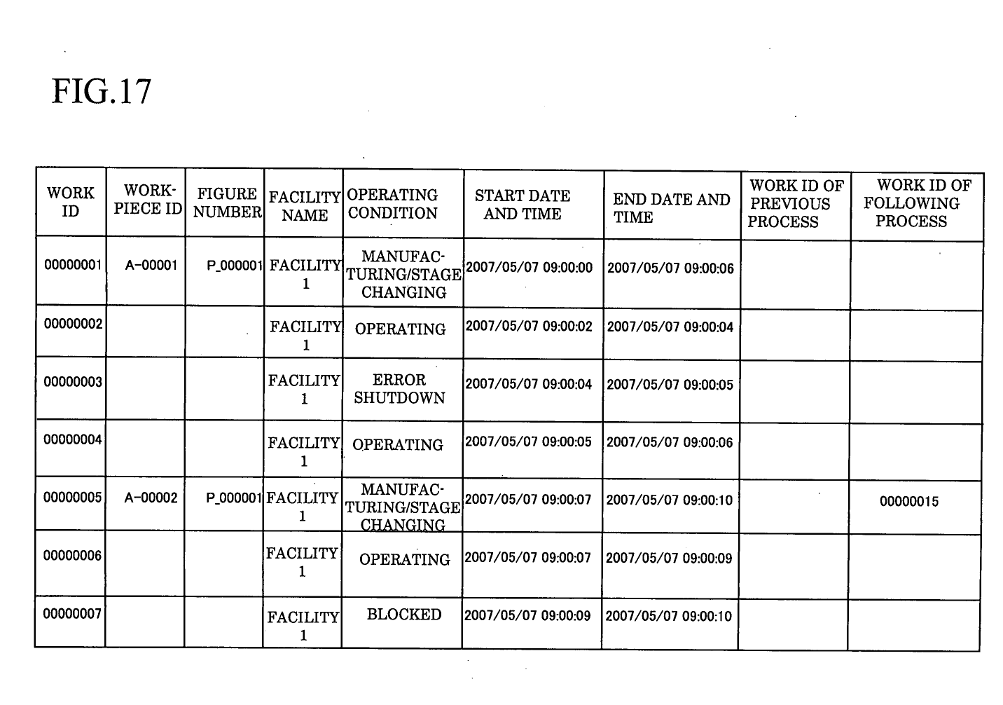

In step S38 of FIG. 12, from the work progress past record information already created, the work progress past record information creation unit 63 searches a work in which the workpiece ID and the facility name respectively match the workpiece ID (A-0001) of the current work (for example, the work whose work ID is “00000008”) and the facility name of the facility that performs the work of the previous process of the current work. The work progress past record information creation unit 63, for example, refers to a facility sequence chart as shown in FIG. 16 stored in advance in storage means which is not shown, and recognizes that the facility that performs the work of the previous process of the current work performed by the facility 2 is the facility 1. From the work progress past record information as shown in FIG. 17, the work progress past record information creation unit 63, for example, identifies the work of the first row (the work whose work ID is “00000001”) in which the workpiece ID is A-0001 and the facility name is facility 1. The facility sequence chart shown in FIG. 16 denotes correspondence information of the title of facility and the work sequence of the facility.

The work progress past record information creation unit 63 determines whether there is a work (previous work) in which the workpiece ID and the facility name respectively match the workpiece ID of the current work and the facility name of the facility that performs the work of the previous process of the current work in step S39. When the work progress past record information creation unit 63 determines that there is no work in which the workpiece ID and the facility name respectively match the workpiece ID of the current work and the facility name of the facility that performs the work of the previous process of the current work, the process proceeds to step S42.

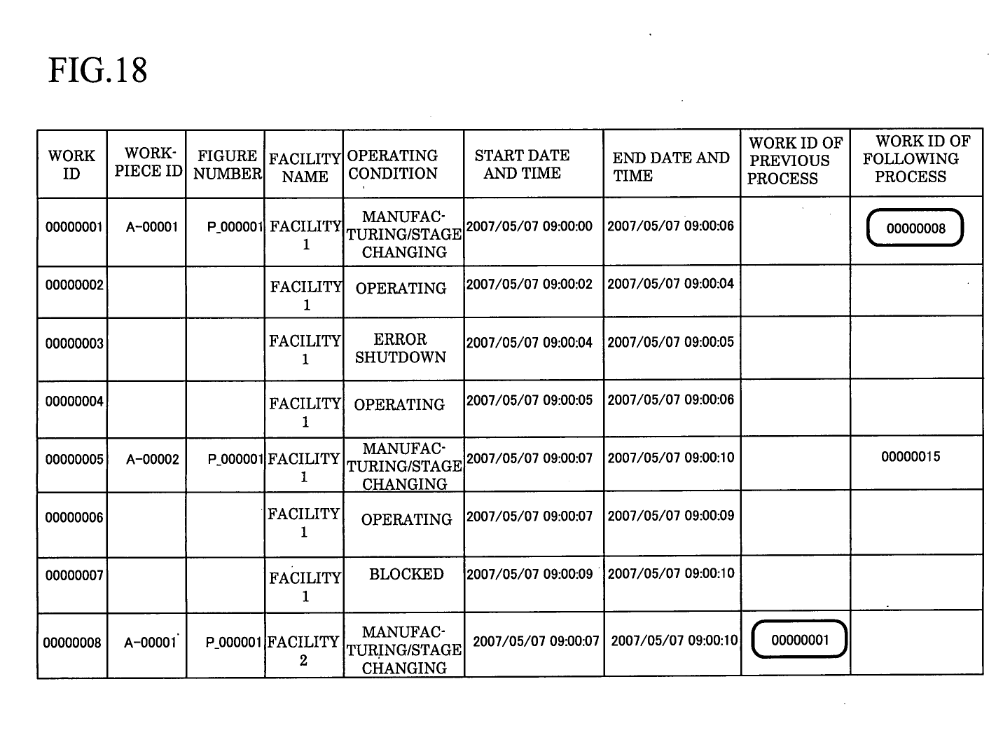

When the work progress past record information creation unit 63 determines that there is a work in which the workpiece ID and the facility name respectively match the workpiece ID of the current work and the facility name of the facility that performs the work of the previous process of the current work, the work progress past record information creation unit 63 stores the work ID of the previous work searched in the step S38 in “work ID of previous process” of the temporary data of the current work and adds the temporary data to the work progress past record information in step S40. For example, “00000001” is stored in “work ID of previous process” of the temporary data shown in FIG. 15, and the temporary data is added to the last row of the work progress past record information as shown in FIG. 18.

In step S41, the work progress past record information creation unit 63 stores the work ID of the current work in “work ID of following process” in the work progress past record information of the previous work searched in the step S38. For example, as shown in the work progress past record information of FIG. 18, the work ID “00000008” of the current work is stored in “work ID of following process” of the record whose work ID is “00000001”.

The work progress past record information creation unit 63 determines whether the processes to the entire facility operation information are finished in step S43. When the work progress past record information creation unit 63 determines that there is facility operation information to which the process is not finished, the process returns to the step S32 of FIG. 11. When the work progress past record information creation unit 63 determines that the processes to the entire facility operation information are finished, the work progress past record information creation unit 63 stores the created work progress past record information in the work progress past record information DB 68 in step S44, and the process ends. In the step S44, the work progress past record information creation unit 63 further deletes the workpiece information and the facility operation information used for creating the work progress past record information.

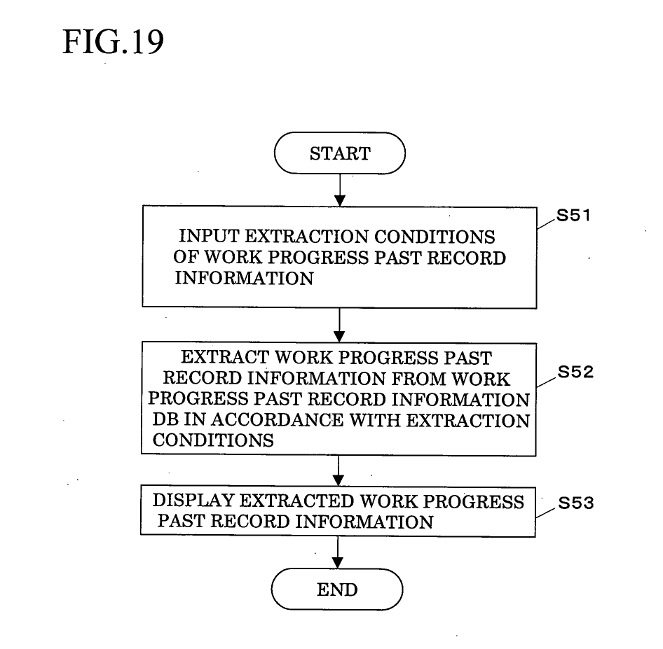

FIG. 19 is a diagram showing an example of a display process flow of the work progress past record information by the work progress past record information display unit. The work progress past record information display unit 64 inputs extraction conditions of the work progress past record information in accordance with the designation and input by an operator in step S51. The work progress past record information display unit 64 then extracts the work progress past record information from the work progress past record information DB 68 in accordance with the inputted extraction conditions in step S52. The work progress past record information display unit 64 displays the extracted work progress past record information in step S53.

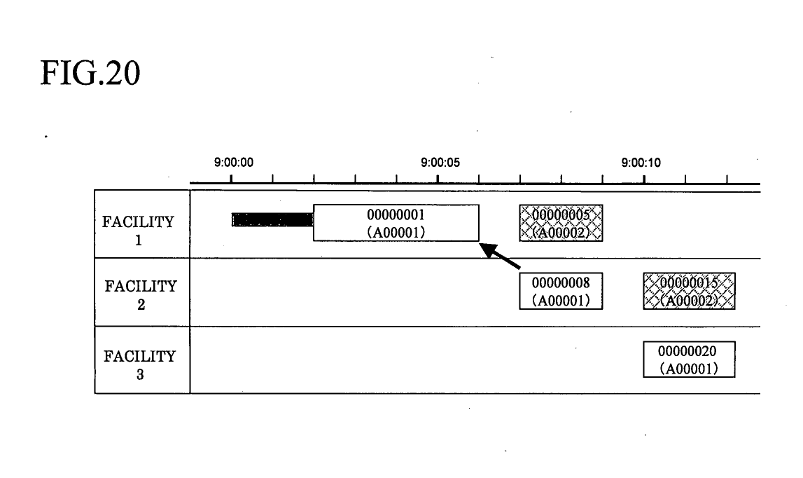

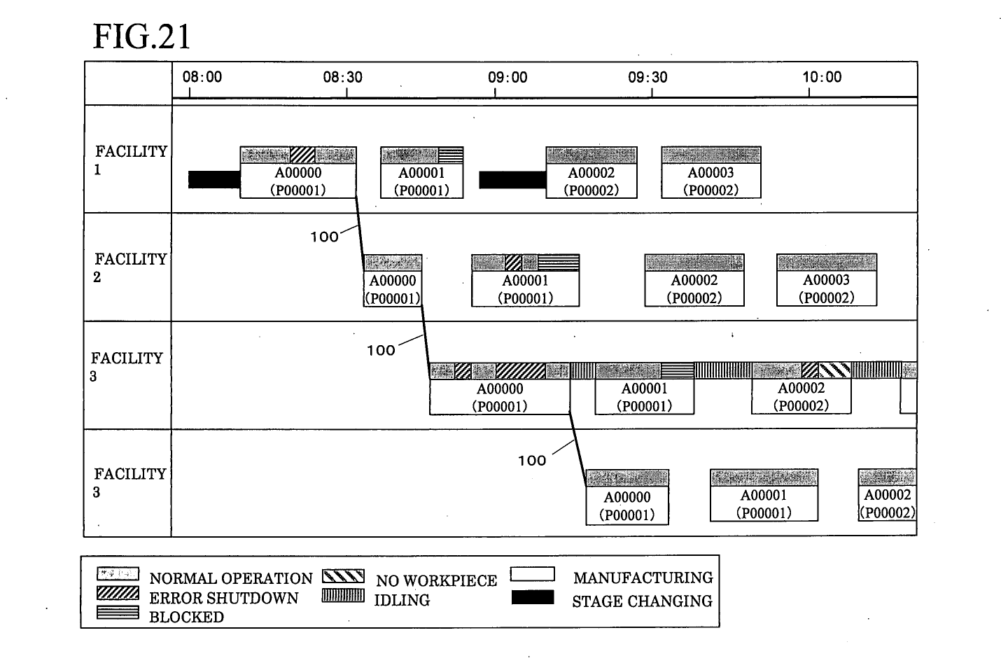

FIGS. 20 and 21 are diagrams showing examples of displaying the work progress past record information conducted by the work progress past record information display unit. In FIG. 20, the example of displaying is illustrated in a form of Gantt chart of the work progress past record information shown in FIG. 18. The horizontal bars (work belts) shown in FIG. 20 denote the works, and among the characters shown in the work belts, the characters on the upper row denote the work IDs, while the characters on the lower row denote the workpiece IDs. The starting point of a work belt denotes the start date and time of a work, and the end point of a work belt denotes the end date and time of the work. According to the present embodiment, the work progress past record information display unit 64 may create information (arrow) indicating that the previous work of the work corresponding to the work ID “00000008” is the work corresponding to the work ID “00000001” based on the work progress past record information shown in FIG. 18, and display the arrow in the Gantt chart as shown in FIG. 20.

FIG. 21 depicts another example of displaying the work progress past record information in a form of a Gantt chart. In the Gantt chart shown in FIG. 21, among the characters displayed in the work belts indicating works of manufacturing, the characters on the upper row denote workpiece IDs, while the characters on the lower row denote figure numbers.

In the example shown in FIG. 21, the work progress past record information display unit 64 creates a Gantt chart in which information indicating each work (manufacturing, stage changing) and information indicating operating conditions of facility in each work are associated. The information indicating the operating conditions of facility in each work is information indicating normal operation, error shutdown, blocked, no workpiece, idling and so on.

In the Gantt chart shown in FIG. 21, on the upper side of the work belts indicating the works of manufacturing, the information indicating operating conditions of the facilities performing the works such as normal operation, error shutdown, blocked, and no workpiece is displayed with horizontal bars. According to the Gantt chart shown in FIG. 21, not only the start date and time of work and the end date and time of work, but also the operating conditions of the working facilities can be checked.

For example, the work belts indicating manufacturing may be color-coded for each workpiece ID, or different shadings may be applied and displayed. The stage changing, operating, error shutdown, blocked, no workpiece, and idling may be displayed with colors or shadings set in advance.

According to the embodiment, the work progress past record information display unit 64 selects a work belt displayed in the Gantt chart in accordance with designation and input by the operator and then refers to the work progress past record information to identify the works before and after the work corresponding to the selected work belt. The work progress past record information display unit 64 may be designed to create, as shown in FIG. 21, connection lines 100, between the work corresponding to the selected work belt and the works before and after the work, indicating the context of works, and then display the connection lines 100 in the Gantt chart. The work progress of the workpieces can be easily checked by the work progress past record information display unit 64 displaying the connection lines 100 indicating the context of works in the Gantt chart.

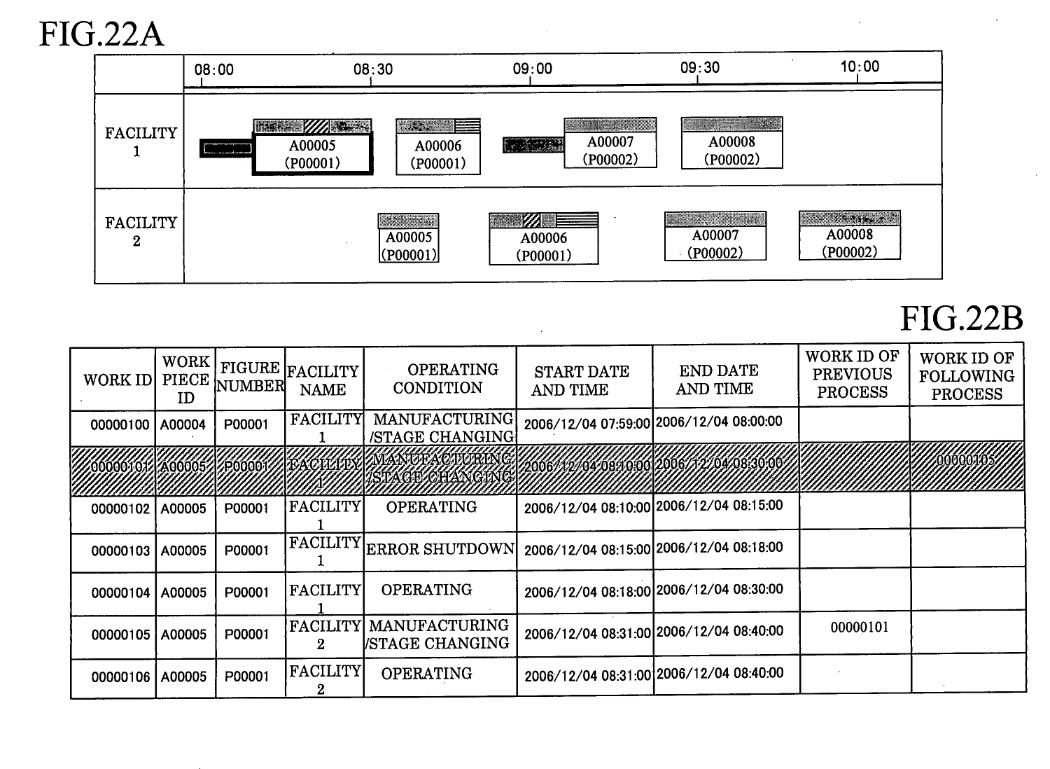

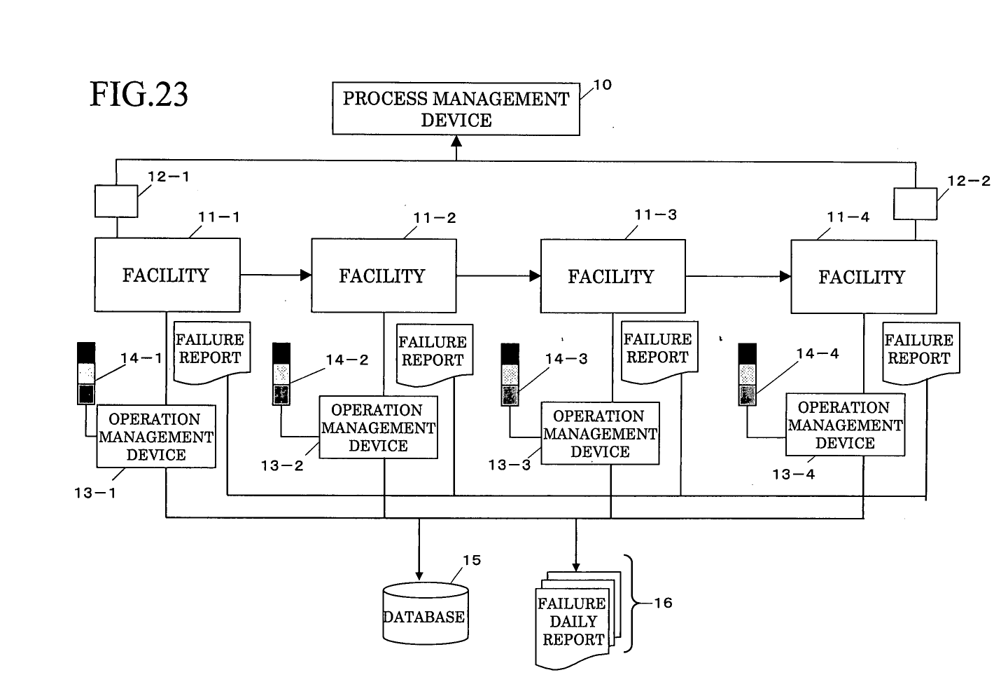

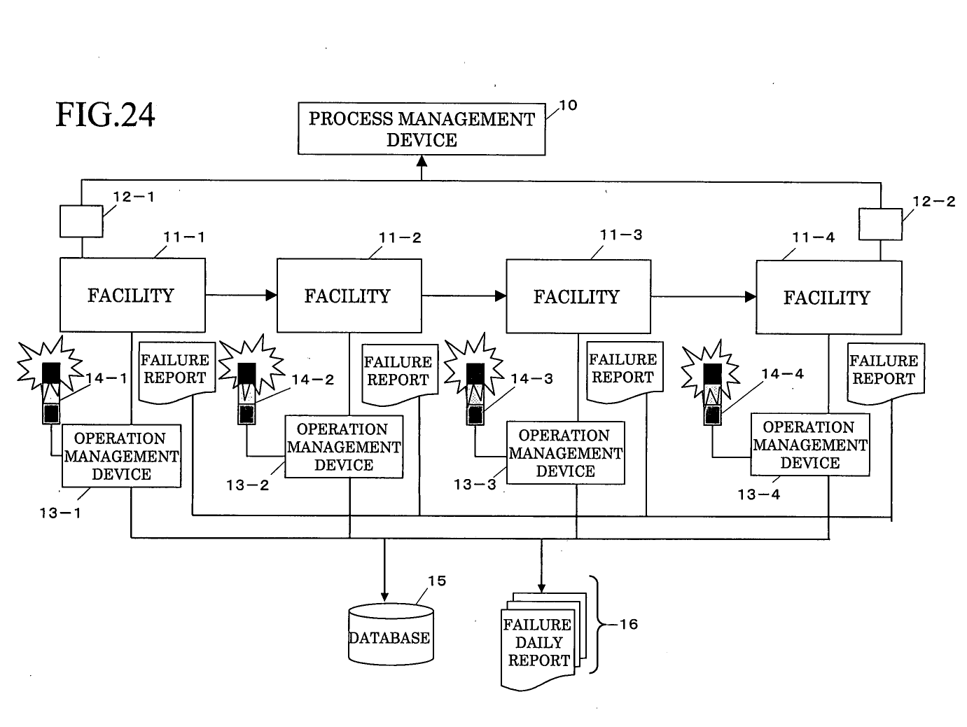

According to the embodiment, once the operator selects a work belt on the Gantt chart, the work progress past record information display unit 64 may specify the work corresponding to the designated work from the work progress past record information stored in the work progress past record information DB 68 and display that the specified work is selected. For example, when the operator selects, on the Gantt chart shown in FIG. 22A, the work belt whose workpiece ID is “A00005”, the figure number is “P00001”, and the operating condition is manufacturing/stage changing, the work progress past record information display unit 64 may specify the work corresponding to the work belt from the work progress past record information shown in FIG. 22B and display the specified work with shading as shown in FIG. 22B.

According to the embodiment, the work progress past record information display unit 64 displays the work progress past record information stored in the work progress past record information DB 68 on the screen, and the operator designates the work whose workpiece ID is “A00005”, the figure number is “P00001”, and the operating condition is manufacturing/stage changing from the work progress past record information displayed on the screen as shown with the shaded part in FIG. 22B. The work progress past record information display unit 64 may display the outer frame of the designated work with thick lines on the Gantt chart as shown in FIG. 22A to indicate that the work is specified.

The operating conditions of each facility and the work progress of the workpieces can be visualized with the above described display process of the work progress past record information conducted by the work progress past record information display unit 64. As a result, normal/abnormal of facilities or problems such as a bottleneck of a process can be checked. Furthermore, the display process is useful for examining whether the problems are specific to the facility or specific to the workpiece (figure number).

As described above, according to the present invention, in which facility an abnormality has occurred can be identified, and at what time and in which facility each target object is being manufactured can be identified.

What is claimed is:

1. A work management apparatus in a manufacturing line in which one or a plurality of target objects are manufactured in a plurality of facilities, comprising:
a first detection unit arranged on each facility and detecting the input and output of the target objects to and from each facility in each facility;
a workpiece information obtaining unit for obtaining, as workpiece information, information of date and time when the target objects enter into each facility and information of date and time when the target objects come out from each facility for every target object and every facility based on the detection result of the first detection unit;
a second detection unit arranged on each facility and detecting operating conditions of each facility; and
an analysis unit for analyzing the operating conditions of each facility and the work progress of the target objects in each facility based on the obtained workpiece information and the information indicating the operating conditions of each facility detected by the second detection unit, and outputting the analysis result.

2. The work management apparatus according to claim 1, wherein the analysis unit comprises:
an operating condition obtaining unit for obtaining information indicating the operating conditions of each facility detected by the second detection unit; and
a work progress past record information creation unit for creating work progress past record information indicating the past records of the work progress of the target objects in each facility based on the obtained information indicating the operating conditions of each facility and the workpiece information obtained by the workpiece information obtaining unit.

3. The work management apparatus according to claim 2, wherein the analysis unit further comprises a matching processing unit for comparing the operating conditions of each facility with reference data of operating conditions of each facility stored in advance in a storage unit and modifying the information indicating the operating conditions of each facility to matched information based on the comparison result.

4. The work management apparatus according to claim 2, wherein the operating condition obtaining unit displays in real time a facility that has become abnormal based on the obtained operating conditions of each facility.

5. The work management apparatus according to claim 1, wherein the analysis unit further comprises a work progress past record information display unit for displaying work progress past record information created by the work progress past record information creation unit.

6. The work management apparatus according to claim 5, wherein the work progress past record information display unit creates and displays a Gantt chart indicating the operating conditions of each facility and the past records of the work progress of each target object based on the work progress past record information.

7. The work management apparatus according to claim 6, wherein the work progress past record information display unit creates a Gantt chart in which the information indicating each work and the information indicating the operating conditions of facility in each work are associated.

8. The work management apparatus according to claim 6, wherein the work progress past record information display unit creates information indicating the context of works in each facility based on the work progress past record information and displays the information in the Gantt chart.

9. A work management method in a manufacturing line in which one or a plurality of target objects are manufactured in a plurality of facilities, comprising:
a step of detecting, in a first detection unit arranged on each facility, the input and output of the target objects to and from each facility in each facility;
a step of obtaining, as workpiece information, information of date and time when the target objects entering into each facility and information of date and time when the target objects come out from each facility for every target object and every facility based on the detection result of the first detection unit;
a step of detecting, in a second detection unit arranged on each facility, operating conditions of each facility; and
a step of analyzing the operating conditions of each facility and the work progress of the target objects in each facility based on the obtained workpiece information and the operating conditions of each facility detected by the second detection unit, and outputting the analysis result.

10. The work management method according to claim 9, wherein the step of analyzing the operating condition of each facility and the work progress of the target objects in each facility comprises:
an operating condition obtaining step of obtaining information indicating the operating conditions of each facility detected by the second detection unit, and
a work progress past record information creation step of creating work progress past record information indicating the past records of the work progress of the target objects in each facility based on the obtained information indicating the operating conditions of each facility and the obtained workpiece information.

11. The work management method according to claim 10, wherein the step of analyzing the operating conditions of each facility and the work progress of the target objects in each facility further comprises a matching processing step of comparing the operating conditions of each facility with reference data of operating conditions of each facility stored in advance in a storage unit and modifying the information indicating the operating conditions of each facility to matched information based on the comparison result.

12. The work management method according to claim 10, wherein the operating condition obtaining step displays in real time a facility that has become abnormal based on the obtained operating conditions of each facility.

13. The work management method according to claim 9, wherein the step of analyzing the operating conditions of each facility and the work progress of the target objects in each facility further comprises a work progress past record information display step of displaying the created work progress past record information.

14. The work management method according to claim 13, wherein the work progress past record information display step creates and displays a Gantt chart indicating the operating conditions of each facility and the past records of the work progress of each target object based on the work progress past record information.

15. The work management method according to claim 14, wherein the work progress past record information display step creates a Gantt chart in which the information indicating each work and the information indicating the operating conditions of facility in each work are associated.

16. The work management method according to claim 14, wherein the work progress past record information display step creates information indicating the context of works in each facility and displays in the Gantt chart based on the work progress past record information.
